(19) United States
(12) Patent Application Publication
(10) Pub. No.: US 2023/0311816 A1
(43) Pub. Date: Oct. 5, 2023

(54) WIPER BLADE DEVICE FOR A WIPER WITH SPRAY FUNCTION

(71) Applicant: Robert Bosch GmbH, Stuttgart (DE)

(72) Inventor: Denis Parenta, Veternik (RS)

(21) Appl. No.: 18/041,867

(22) PCT Filed: Jun. 18, 2021
(86) PCT No.: PCT/EP2021/066583

§ 371 Date: Feb. 16, 2023

(30) Foreign Application Priority Data
Aug. 18, 2020 (DE) 10 2020 210 447.6

(51) Int. Cl. B60S 1/38; B60S 1/52; B60S 1/48

(52) U.S. Cl. CPC B60S 1/3862; B60S 1/522; B60S 1/488; B60S 1/40

(57) ABSTRACT

The present invention relates to a wiper blade device (14) for a wiper of a vehicle, wherein the wiper blade device (14) is fixable to a wiper arm (12) of the wiper, wherein the wiper blade device (14) comprises a wiper blade (22) and a carrier (24) and optionally a spoiler, wherein the wiper blade device (14) has a liquid-discharging system (26) comprising at least one liquid-discharging channel, wherein the liquid-discharging channel has discharging openings for discharging cleaning liquid from the liquid-discharg-ing channel onto a pane of the vehicle, wherein at least one adapter (28) for hydraulically connecting a liquid supply (30) to the liquid-discharging system (26) is fixed on the carrier (24), wherein each of one or more adapters (28) arranged on the carrier (24) is configured to connect the liquid-discharging system (26), through which cleaning liquid can be discharged uni-laterally and on the same side of the wiper blade (22).

### BACKGROUND

The present invention relates to a wiper blade device for a wiper with a spray function. The present invention relates, in particular, to a wiper blade device which has a particularly adaptive and cost-effective attachment and fixing of a liquid reservoir.

Wipers for vehicles are known in many different designs. It is also known to provide the wipers with a spray function so that cleaning liquid can be sprayed directly by the wiper onto a pane of the vehicle to be cleaned. The cleaning liquid can be applied, for example, on one side or two sides relative to a wiper blade of the wiper.

DE 10 2008 049 269 A1 describes a connection between a wiper blade and a wiper arm of a wiper system for vehicles, with a wiper blade adapter provided on the wiper blade for releasably fastening the wiper blade to the wiper arm, wherein the wiper blade is configured as a flat wiper blade, substantially consisting of a profile rail-like wiper blade body, made from at least one spring rail and from a wiper rubber forming at least one wiper lip, and on at least one wiper blade longitudinal side has at least one spray or distribution channel with nozzle openings for applying a cleaning or washing liquid to a vehicle pane and with at least one liquid connection on the wiper blade adapter for releasably connecting the at least one spray and distribution channel to at least one outer liquid line provided at least over a partial length on the wiper arm, for supplying the washing and cleaning liquid to the at least one spray or distribution channel, and namely via a coupling unit which is connected to the at least one liquid line.

### SUMMARY

A wiper blade device for a wiper of a vehicle is described, wherein the wiper blade device is fixable to a wiper arm of the wiper, wherein the wiper blade device comprises a wiper blade and a carrier and optionally a spoiler, wherein the wiper blade device has a liquid-discharging system comprising at least one liquid-discharging channel, wherein the liquid-discharging channel has discharging openings for discharging cleaning liquid from the liquid-discharging channel onto a pane of the vehicle, wherein at least one adapter for hydraulically connecting a liquid supply to the liquid-discharging system is fixed on the carrier, wherein each of one or more adapters arranged on the carrier is configured to connect the liquid supply only to one or more such liquid-discharging channels of the liquid-discharging system through which cleaning liquid can be discharged on one side and on the same side of the wiper blade.

Such a wiper blade device permits an embodiment which is cost-effective and adaptable to the use of a wiper for a vehicle.

The wiper blade device serves, in particular, as part of a wiper for a vehicle, such as in particular for a motor vehicle. To this end, the wiper blade device is fixable or is fixed to a wiper arm of the wiper. The wiper arm can thus serve, in particular, for a mechanical connection of the wiper blade device to the motor vehicle and to this end is provided, in particular, to be pivotably fastened adjacent to a pane of the vehicle. Moreover, the wiper arm can be driven by the wiper motor in a manner known per se. The wiper blade device is then guided by the wiper arm and slides along a pane of the vehicle.

To this end, in one embodiment, the wiper blade device can have a wiper strip, a spoiler which can be fastened thereto and a wiper blade which can be fastened to the wiper strip or the spoiler. The wiper strip can be produced, for example, from metal and provide the wiper blade device with mechanical stability. Moreover, the wiper strip can serve to hold the spoiler and optionally the wiper blade. In the case of high speeds, the spoiler serves in a manner known per se to press the wiper against the pane, in order to permit thereby a good wiping result.

The wiper blade comprises, in particular, a rubber lip which slides directly along the pane and thus removes liquid and dirt from the pane and thus cleans the pane.

Regarding an operation of the wiper or the wiper blade device, it can be preferred if it is designed to spray cleaning liquid, such as for example water mixed with a detergent and/or antifreeze, onto the pane. As a result, it can be ensured that the pane is cleaned particularly effectively and above all rapidly of dirt. This is because by spraying the cleaning liquid onto the pane by the wiper blade device, in particular by the wiper blade or the spoiler, the cleaning liquid can be sprayed on accurately in terms of position and over the entire surface in the desired manner at the point where the wiper cleans the pane. Thus an application of cleaning liquid on the pane by the wiper blade device permits improved safety. Moreover, cleaning liquid can be saved during an operation of the wiper.

To this end, the wiper blade device comprises a wiper blade and a carrier and optionally a spoiler, as indicated above. The wiper blade serves to come into direct contact with the pane of the vehicle and thus to clean the pane, as indicated above. In order to permit cleaning liquid to be sprayed from the wiper blade device, such as for example the wiper blade or the spoiler, onto the pane, the wiper blade device has a liquid-discharging system comprising at least one liquid-discharging channel, wherein one or more liquid-discharging channels can be arranged in the wiper blade and/or the spoiler. The liquid-discharging channel or channels comprise discharging openings for discharging cleaning liquid from the liquid-discharging channel onto the pane of the vehicle. The discharging openings, also to be denoted as nozzle openings, can be distributed, in particular, over the length of the wiper blade or the spoiler and thus ensure that cleaning liquid is sprayed adjacent to the wiper blade over the entire length of the wiper blade. In particular, the cleaning liquid can then be sprayed at least in the direction of movement of the wiper upstream of the wiper blade.

The carrier can be, for example, the above-described wiper strip or another carrier which can be fastened, for example, to the wiper strip. It is important that the carrier can carry at least one adapter or that at least one adapter can be fixed to the carrier. This is because it is provided in the wiper blade device described herein that at least one adapter is fixed to the carrier for hydraulically connecting a liquid supply to the liquid-discharging system. The adapter thus serves, in particular, to be connected to a liquid supply which can be a hose, for example, which is connected to a reservoir for cleaning liquid. This can be implemented, for example, by the adapter having a connector as a liquid inlet which can be configured as a male connector and onto which, for example, the hose can be pushed. Moreover, the adapter has one, for example exactly one, liquid outlet which for example can also be a male connector and which can be connected to the liquid-discharging system, for example by using a hose or another liquid guiding means. In particular, each adapter provided can have exactly one liquid inlet and one liquid outlet.

Thus a channel geometry is provided inside the adapter by which cleaning liquid can be conducted from the liquid inlet to the liquid outlet.

Each of one or more adapters arranged on the carrier is also designed to connect the liquid supply only to one or more such liquid-discharging channels of the liquid-discharging system through which cleaning liquid can be discharged on one side and on the same side of the wiper blade. The same side of the wiper blade is to be understood to mean, in particular, that during a movement of the wiper blade in a fixed direction of movement cleaning liquid is discharged on the side upstream or downstream of the wiper blade.

Thus one adapter or a plurality of adapters is provided on the carrier, the adapters being designed and connected regarding connectivity to the liquid-discharging system such that each adapter per se permits only a one-sided discharge of the cleaning liquid. Thus it is not provided that one adapter is able to discharge the cleaning liquid on both sides, but each adapter conducts cleaning liquid into the liquid-discharging system or into a liquid-discharging channel such that the cleaning liquid coming from the adapter is sprayed onto the pane only on one side relative to the wiper blade.

Such an embodiment permits clear advantages relative to the solutions from the prior art.

In particular, this embodiment can permit the provision of one or more adapters to be adapted to the actual embodiment of the cleaning mechanism. Thus, for example, in the case of a cleaning mechanism which provides a one-sided spraying of the cleaning liquid, it is possible to provide only one adapter. However, if two-sided spraying of the cleaning liquid is provided in a cleaning mechanism, two adapters can be provided.

As a result, a particularly cost-effective solution can be permitted. This is because the respective adapters can be adapted in each case to one-sided spraying, which makes the adapters smaller and able to be produced using less material. As a result, a cost-effective solution can be provided, for example, with one-sided spraying and the use of a relatively small adapter.

Moreover, in the case of a one-sided spraying mechanism it is possible to prevent an adapter being used in which two liquid outlets are provided but one liquid outlet thereof is not used. Then either one liquid outlet would ideally have to be closed, or the risk would be present of dirt entering the open connector which could impair the cleaning result or even block up the adapter.

A connector of an adapter which is not used since it is non-functional can also make operation difficult, for example when changing the wiper, since the user generally excludes or does not expect such a non-functional connector.

If the liquid-discharging system, however, is intended to be designed for the two-sided spraying of the cleaning liquid, two adapters can be used in a simple manner in order to conduct cleaning liquid into corresponding liquid-discharging channels.

Thus a modular system is permitted in which a very adaptable embodiment is permitted in a simple and cost-effective manner without affecting the functionality.

It can be preferred that the wiper blade device is designed for the one-sided discharge of cleaning liquid and has one, in particular exactly one, adapter which has exactly one liquid outlet for connecting the adapter to one or more liquid-discharging channels through which cleaning liquid can be discharged on one side and on the same side of the wiper blade, and thus a discharge of the cleaning liquid on only one side is possible. In such an embodiment, which serves for only one-sided spraying of the cleaning liquid, the consumption of the cleaning liquid can be further reduced, which can permit a particularly cost-effective operation. Moreover, in this embodiment the adapter can be designed in a particularly simple manner which can further reduce the production effort and the costs of the adapter. Thus only one potentially compact adapter needs to be used for manufacturing the wiper blade device, which simplifies the production and saves costs.

A one-sided spraying of the cleaning liquid, in particular, can take place such that with a movement of the wiper the cleaning liquid is sprayed upstream of the moving wiper blade, but only in a fixed direction of movement of the wiper or the wiper blade, due to the one-sided spraying functionality.

Alternatively, it can be preferred that the wiper blade device is designed for the two-sided discharge of cleaning liquid and has two adapters, in particular exactly two adapters, each of the adapters having exactly one liquid outlet for connecting the adapter to one or more liquid-discharging channels through which cleaning liquid can be discharged on one side and on the same side of the wiper blade, i.e. only a one-sided discharge of cleaning liquid is possible, wherein the liquid-discharging channels which are supplied by different adapters are configured to discharge cleaning liquid on different sides of the wiper blade relative to one another. In this embodiment the cleaning result can be particularly advantageous, since with each movement of the wiper, i.e. in both directions of movement of the wiper, cleaning liquid is sprayed upstream thereof

The adapters which are used can be configured to be identical so that only one type of adapter needs to be used, irrespective of whether a one-sided or a two-sided spraying of the cleaning liquid is to be implemented. This shows that a very high level of functional adaptability is possible due to the modular construction of the wiper blade device.

It can also be preferred that at least one of the adapters which is provided is fastened indirectly or directly to the carrier by a latching connection. A latching connection, which can also be denoted as a clip connection, can further simplify the production since a fixing of the adapter or the adapters to the carrier is possible without the use of tools. Moreover, latching connections, i.e. in particular latching lugs and corresponding undercuts, can be easily formed and arranged so that the adapter or the adapters can be fixed in a simple manner at a corresponding point if this is desired. This embodiment can thus further increase the modular character of the wiper blade device as described herein.

A fixing of the adapter to the carrier can take place directly, i.e. without the interposition of further components between the carrier and adapter, or indirectly, i.e. with at least one component between the adapter and the carrier.

It can also be preferred that a housing is fixed to the carrier, at least one adapter being fastened to the housing. This embodiment thus describes an indirect fixing of the adapter or the adapters to the carrier. In this embodiment, the adapter and the connectors of the adapter can be protected from external negative influences, such as for example mechanical influences. As a result, a safe and long-term stable operation of the wiper blade device can be ensured.

Regarding the housing, it can also be advantageous if the housing is fastened to the carrier by a latching connection. This results, in turn, in the advantages of a simple and safe modular fixing and adaptation of the wiper blade device. In principle, a housing can be provided for all of the adapters or a housing can be provided for each adapter.

It can also be preferred that the liquid-discharging system, in particular the liquid-discharging channel(s) of the wiper blade or the spoiler, can be heated. In this embodiment, therefore, the wiper blade device can have a heating system, the cleaning liquid in the liquid-discharging system being able to be heated thereby. In this embodiment, a reliable operation of the wiper blade device can be ensured even at temperatures significantly below freezing point. Preferably, to this end it can be provided that an electrical connector is provided on the carrier for electrically connecting an electrical heating system for heating the liquid-discharging system.

Regarding further advantages and technical features of the wiper blade device, reference is made to the description of the wiper arrangement, to the figures and to the description of the figures.

A wiper arrangement comprising a wiper arm and a wiper blade device is also described, wherein the wiper blade device is designed as has been described in detail above.

Such a wiper arrangement permits, as described above in detail, a cost-effective and highly adaptable solution of a wiper blade device and thus the wiper arrangement described herein.

Preferably, the wiper arm can carry a liquid supply which can be heated. The liquid supply, which is arranged on the wiper arm, can be a hose, for example, which is connected to a reservoir for cleaning liquid and also to the adapter of the wiper blade device. By heating the liquid supply, i.e. for example the hose, a reliable operation of the wiper blade device can be ensured even at temperatures significantly below freezing point.

### BRIEF DESCRIPTION OF THE DRAWINGS

Regarding further advantages and technical features of the wiper arrangement, reference is made to the description of the wiper blade device, to the figures and to the description of the figures.

Further advantages and advantageous embodiments of the objects according to the invention are illustrated by the drawing and explained in the following description, wherein the described features can constitute individually or in any combination an object of the present invention, unless the context clearly dictates otherwise. It should be noted that the drawing has only the described character and is not intended to limit the invention in any way. In the drawing

FIG. 1 shows a schematic view of a wiper arrangement according to one embodiment of the present invention;

FIG. 2 shows a schematic view of a wiper blade device according to one embodiment of the present invention;

FIG. 3 shows a schematic view of a wiper blade device according to a further embodiment of the present invention;

FIG. 4 shows a schematic view of a wiper blade device according to a further embodiment of the present invention;

FIG. 5 shows a schematic view of a wiper blade device according to a further embodiment of the present invention;

FIG. 6 shows a schematic view of a wiper blade device according to a further embodiment of the present invention.

### DETAILED DESCRIPTION

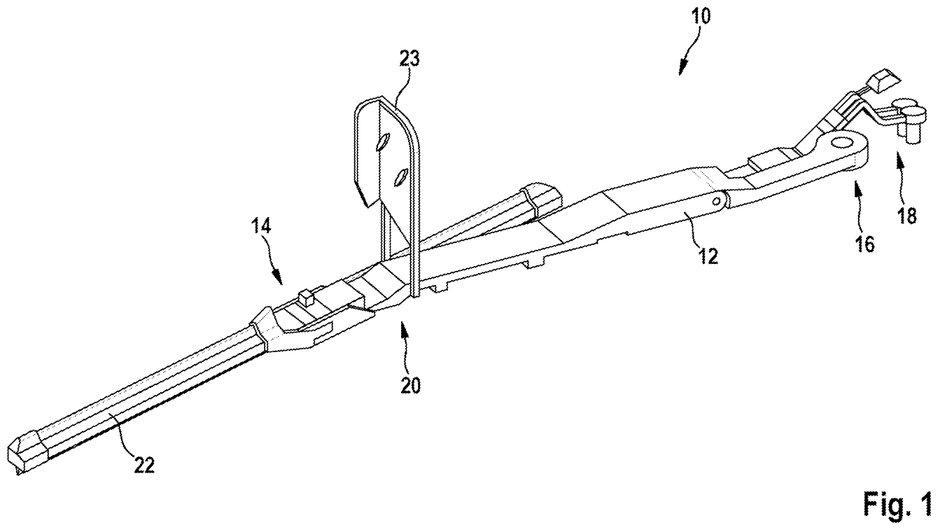

A wiper arrangement 10 which is provided for a vehicle, for example for a motor vehicle, is shown in FIG. 1. The wiper arrangement 10 has a wiper arm 12 and a wiper blade device 14. The wiper arm 12 is pivotably fixable at a first end 16 to the motor vehicle. Electrical connectors 18 which enable, for example, a heating of the wiper arm 12 or the wiper blade device 14 are also shown at the first end 16. It is also shown that the wiper blade device 14 is fixed at a second end 20 of the wiper arm 12.

The wiper blade device 14 is shown in the further figures in detail and in various embodiments.

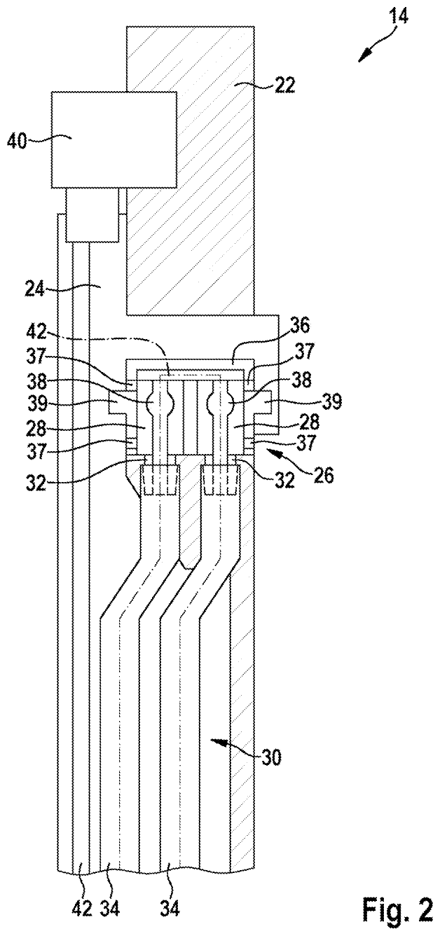

For example, it is shown in FIG. 2 that the wiper blade device 14 comprises a wiper blade 22 and a carrier 24. The wiper blade 22 is fixed to the carrier 24. The carrier 24 can also serve to connect the wiper blade device 14 on its carrier 24 mechanically to the wiper arm 12.

In order to permit spraying cleaning liquid onto a pane of the vehicle, it is provided that the wiper blade device 14 has a liquid-discharging system 26 comprising at least one liquid-discharging channel, not shown in detail, wherein the liquid-discharging channel also has discharge openings, not shown in detail, for discharging cleaning liquid from the liquid-discharging channel onto a pane of the vehicle.

At least one adapter 28 for hydraulically connecting a liquid supply 30 to the liquid-discharging system is also fixed to the carrier 24. Two adapters 28 which are connected to the liquid supply 30 are shown in detail in FIG. 2. The adapters 28 have in each case a liquid inlet 32 which is configured as a male connector. The liquid supply 30 also comprises a hose 34, in the embodiment according to FIG. 2 two hoses 34, which are connected to a reservoir, such as for example a tank, for cleaning liquid.

The adapters 28 are connected via a latching connection to a housing 36 by latching means 37, wherein the housing 36 in turn is connected via a latching connection by latching means 39 to the carrier 24. It can be seen that a common housing 36 is provided for both adapters 28. The region of the adapters 28 and the housing 36 can be covered by a housing flap 23, as is shown in FIG. 1.

In the embodiment according to FIG. 2, it is also provided that the wiper blade device 14 is designed for the two-sided discharge of cleaning liquid and has two adapters 28, each of the adapters 28 having exactly one liquid outlet 38 for connecting the adapter 28 and thus the liquid supply 30 to one or more liquid-discharging channels through which cleaning liquid can be discharged on one side and on the same side of the wiper blade 22. The adapters 28 are thus individual components and separated from one another, but in principle can be designed so as to correspond to one another, as a mirror-image of one another or differently from one another.

In principle, it is thus provided that each of one or more adapters 28 arranged on the carrier 24 is designed to connect the liquid supply 30 only to one or more such liquid-discharging channels of the liquid-discharging system 26 through which cleaning liquid can be discharged on one side and on the same side of the wiper blade 22.

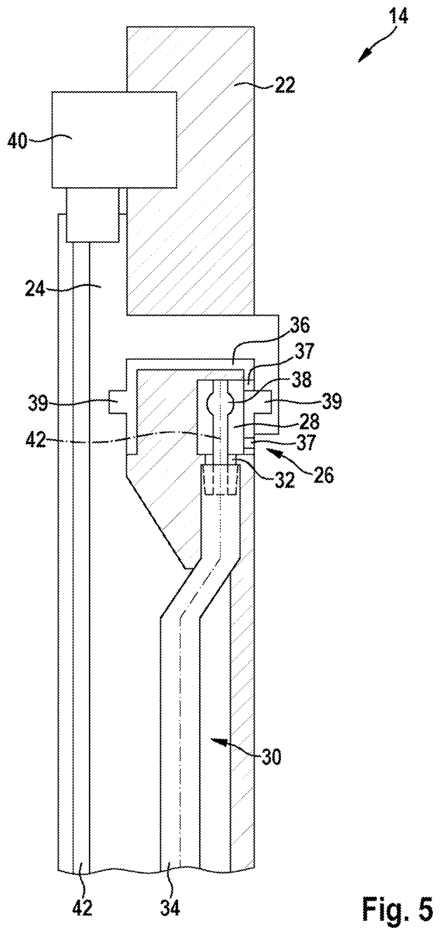

This is also shown in FIG. 5, for example, in which a wiper blade device 14 which is designed for the one-sided discharge of cleaning liquid is shown. In this embodiment, the wiper blade device 14 has exactly one adapter 28 which has exactly one liquid outlet 38 for connecting the adapter 28 and thus the liquid supply 30 to one or more liquid-discharging channels through which cleaning liquid can be discharged on one side and on the same side of the wiper blade 22.

It can be identified in the embodiment according to FIG. 5 that an adapter 28 can be dispensed with, due to the spray functionality on only one side, in contrast to the embodiment of FIG. 2.

An electrical connector 40 which can be connected, for example, to the electrical connectors 18 on the wiper arm 12 is also shown in FIGS. 2 and 5. These electrical connectors can permit a heating system, not shown in detail, to be activated via electrical lines 42, so that the wiper arm 12 and/or optionally the liquid supply 30 and equally the liquid-discharging system 26, such as for example the channels in the wiper blade 12, can be heated.

The further figures, however, show further corresponding embodiments of a wiper blade device, as set forth hereinafter, wherein in particular the differences are described.

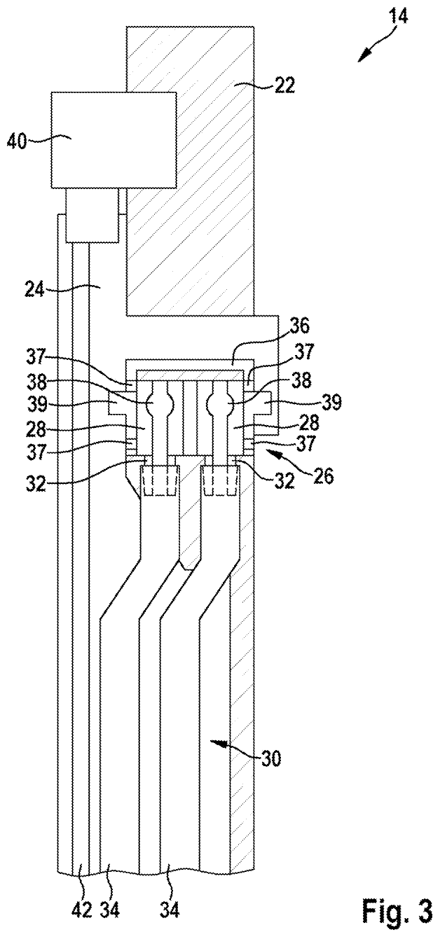

In FIG. 3 in turn an embodiment is shown in which the wiper blade device 14 is provided for a two-sided spraying of the cleaning liquid. It is provided by corresponding electrical lines 42 that only the liquid-discharging system 26, but not the wiper arm 12, can be heated.

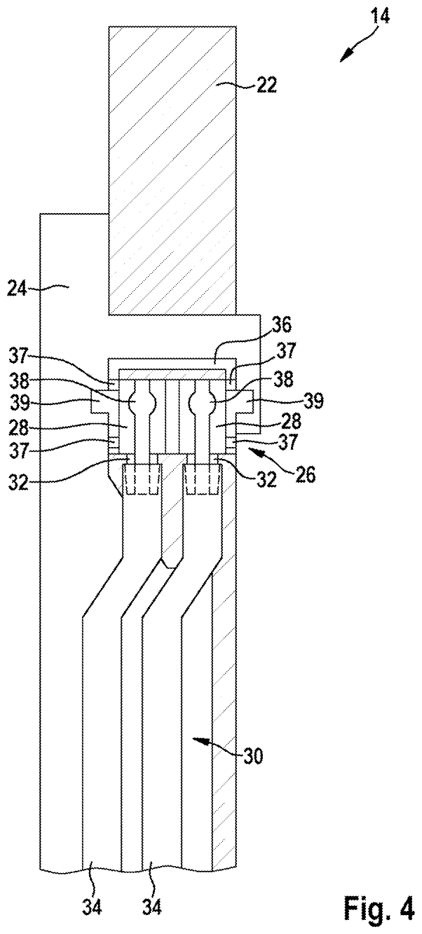

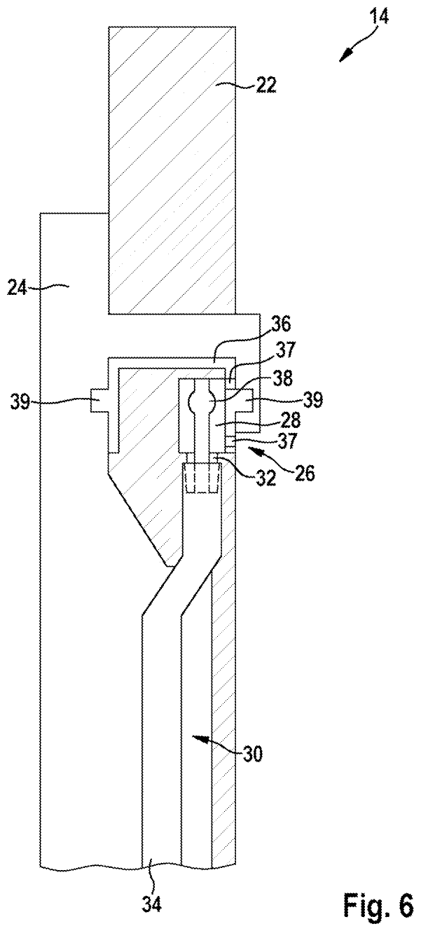

FIGS. 4 and 6 show embodiments without a heating system, wherein in FIG. 4 the wiper blade device 14 is provided for a two-sided spraying of the cleaning liquid and wherein in FIG. 6 the wiper blade device 14 is provided for a one-sided spraying of the cleaning liquid. Accordingly, an electrical connector can be dispensed with.

In principle, however, in the corresponding embodiments of FIGS. 2 and 5 and 4 and 6 it can be shown that a cost-effective and adaptable solution which permits an unlimited functionality is provided by the modular construction of the wiper blade device 14 according to the invention.

1. A wiper blade device (14) for a wiper of a vehicle, wherein the wiper blade device (14) is fixable to a wiper arm (12) of the wiper, wherein the wiper blade device (14) comprises a wiper blade (22) and a carrier (24), wherein the wiper blade device (14) has a liquid-discharging system (26) comprising at least one liquid-discharging channel, wherein the liquid-discharging channel has discharging openings for discharging cleaning liquid from the liquid-discharging channel onto a pane of the vehicle, characterized in that at least one adapter (28) for hydraulically connecting a liquid supply (30) to the liquid-discharging system (26) is fixed on the carrier (24), wherein each of the at least one adapter (28) is configured to connect the liquid supply (30) only to one or more such liquid-discharging channels of the liquid-discharging system (26) through which cleaning liquid can be discharged on one side and on the same side of the wiper blade (22).

2. The wiper blade device (14) as claimed in claim 1, characterized in that the wiper blade device (14) is designed for the one-sided discharge of cleaning liquid and has one adapter (28) which has exactly one liquid outlet (38) for connecting the adapter (28) to one or more liquid-discharging channels through which cleaning liquid can be discharged on one side and only on the same side of the wiper blade (22).

3. The wiper blade device (14) as claimed in claim 1, characterized in that the wiper blade device (14) is designed for the two-sided discharge of cleaning liquid and has two adapters (28), each of the adapters (28) having exactly one liquid outlet (38) for connecting the adapter (28) to one or more liquid-discharging channels through which cleaning liquid can be discharged on one side and only on the same side of the wiper blade (22), wherein the liquid-discharging channels which are supplied by different adapters (28) are configured to discharge cleaning liquid on different sides of the wiper blade (22) relative to one another.

4. The wiper blade device (14) as claimed in claim 1, characterized in that at least one of the adapters (28) which is provided is fastened indirectly or directly to the carrier (24) by a latching connection.

5. The wiper blade device (14) as claimed in claim 1 4, characterized in that a housing (36) is fixed to the carrier (24), at least one adapter (28) being fastened to the housing.

6. The wiper blade device (14) as claimed in claim 5, characterized in that the housing (36) is fastened to the carrier (24) by a latching connection.

7. The wiper blade device (14) as claimed in claim 1, characterized in that the liquid-discharging system (26) can be heated.

8. The wiper blade device (14) as claimed in claim 7, characterized in that an electrical connector (40) is provided on the carrier (26) for electrically connecting an electrical heating system for heating the liquid-discharging system (26).

9. A wiper arrangement (10) comprising a wiper arm (12) and a wiper blade device (14), characterized in that the wiper blade device (14) is designed as claimed in claim 1.

10. The wiper arrangement (10) as claimed in claim 9, characterized in that the wiper arm (12) carries a liquid supply (30) which can be heated.

11. The wiper blade device (14) as claimed in claim 1, further comprising a spoiler.
